(19) United States
(12) Patent Application Publication
(10) Pub. No.: US 2013/0146577 A1
(43) Pub. Date: Jun. 13, 2013

(54) VEHICLE MOUNTED OPTICAL AND SENSOR CLEANING SYSTEM

(71) Applicant: Continental Automotive Systems, Inc., Auburn Hills, MI (US)

(72) Inventors: Andrew Malcolm Haig, Birmingham, MI (US); Michael Joseph Zaitz, Royal Oak, MI (US); Nicholas Pinazzo, Madison Heights, MI (US); Craig Belevender, Clarkston, MI (US); Christian Schumacher, Lake Orion, MI (US)

(73) Assignee: Continental Automotive Systems, Inc., Auburn Hills, MI (US)

(21) Appl. No.: 13/706,661

(22) Filed: Dec. 6, 2012

Related U.S. Application Data
(60) Provisional application No. 61/568,442, filed on Dec. 8, 2011.

(51) Int. Cl. B60H 1/00; B08B 3/04

(52) U.S. Cl. CPC B60H 1/0025; B08B 3/04
USPC 219/202; 134/18

(57) ABSTRACT

A sensor or camera assembly for a vehicle comprises a housing that is mountable to a vehicle component. The sensor or camera is located within the housing and has an exterior facing surface. A defrost element is located proximate to the sensor or camera and is electrically connectable to a defrost system. The defrost element is arranged to defrost the surface of the sensor or camera. A nozzle is located proximate to the sensor or camera and is fluidly connectable to a washer system for the vehicle. The nozzle is arranged to direct a fluid from the washer system over the surface of the sensor or camera. Therefore, the camera or sensor cleaning system minimizes any reduction in effectiveness and efficiency of the sensor by use of the clean or defrost feature. Maintaining effectiveness and efficiency of the sensor provides a key improvement in safety for the vehicle.

### PRIORITY

This application is a non-provisional of, and claims priority to the Dec. 8, 2011, filing date of, U.S. provisional patent application Ser. No. 61/568,442, the entire content of which is incorporated herein by reference.

### TECHNICAL FIELD

The present disclosure relates to automotive vehicles and more particularly to cameras and sensors for automotive vehicles.

### BACKGROUND

During use automotive vehicles collect dust and debris that may obscure the operator's point of view. In colder climates ice may also form on these surfaces. Automotive vehicles are typically equipped with windshield washer systems and the heating system typically includes defrosting options. Recently, the washing and heating systems have been expanded to also provide fluid and/or defrosting to other locations on the vehicle such as rear windows and headlamps.

Automotive vehicles are now including externally mounted cameras for driver assistance systems, such as back up assist and parking assist. These cameras frequently become obscured as a result of dirt and debris. When the external cameras are obscured the driver assist programs have limited or no operational capacity. Therefore, vehicle washing systems are sometimes used to clean the camera surface.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A sensor or camera for a vehicle comprises a housing that is mountable to a vehicle component. The sensor/camera is located within the housing and has an exterior facing surface. A defrost element is located proximate to the sensor/camera and is electrically connectable to a defrost system. The defrost element is arranged to defrost the exterior surface of the sensor/camera. A nozzle is located proximate to the sensor/camera and is fluidly connectable to a washer system for the vehicle. The nozzle is arranged to direct a fluid of the washer system over the surface of the sensor/camera.

A sensor or camera assembly for a vehicle comprises a sensor/camera housing that is mountable to a vehicle component. A sensor/camera is located within the sensor/camera housing and has an exterior facing surface. A nozzle is located proximate to the sensor/camera and fluidly connectable to a washer system for the vehicle. The nozzle is arranged to direct a fluid of the washer system over the surface of the sensor/camera.

A method of cleaning a sensor or camera for a vehicle comprises defrosting a surface of a sensor/camera with a defrost element located proximate to the surface, and spraying a fluid from a washer system for the vehicle from a nozzle located proximate to the surface.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle having a cleaning and defrosting system of the present invention;

FIG. 2A is a schematic exterior perspective illustration of a first embodiment of the cleaning and defrosting system of FIG. 1;

FIG. 2B is a schematic interior perspective illustration of the first embodiment of the cleaning and defrosting system of FIGS. 1-2A;

FIG. 3 is a schematic partial cross-section illustration of the first embodiment of the cleaning and defrosting system of FIGS. 1-2B;

FIG. 4A is a schematic exterior perspective illustration of a second embodiment of the cleaning and defrosting system of FIG. 1;

FIG. 4B is a schematic interior perspective illustration of the second embodiment of the cleaning and defrosting system of FIGS. 1 and 4A;

FIG. 5 is a schematic partial cross-section illustration of the second embodiment of the cleaning and defrosting system of FIGS. 1 and 4A-4B;

FIG. 6A is a schematic exterior perspective illustration of a third embodiment of the cleaning and defrosting system of FIG. 1;

FIG. 6B is a schematic interior perspective illustration of the third embodiment of the cleaning and defrosting system of FIGS. 1 and 6A; and

FIG. 7 is a schematic partial cross-section illustration of the third embodiment of the cleaning and defrosting system of FIGS. 1 and 6A-6B.

### DETAILED DESCRIPTION

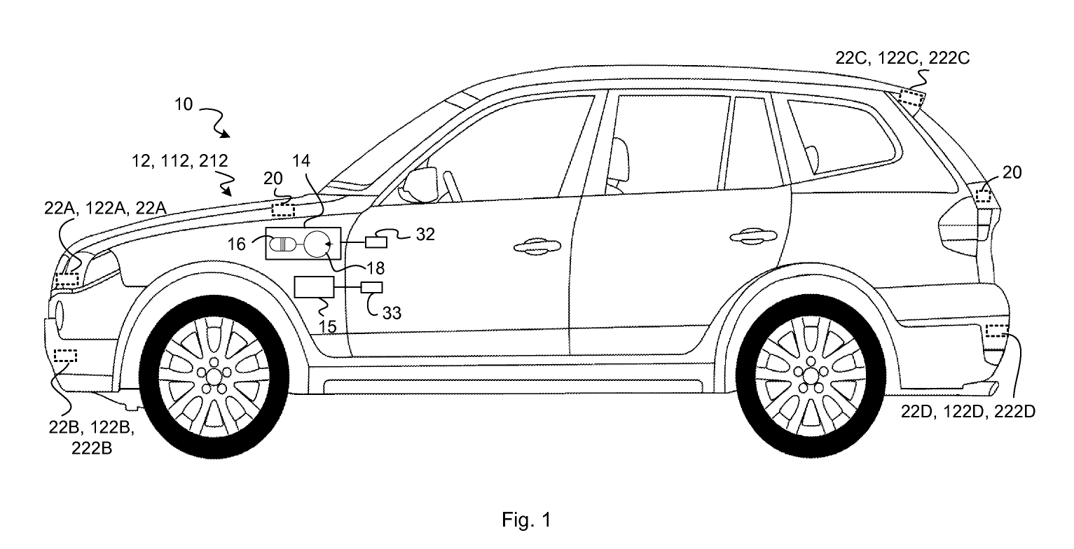

The following description is merely exemplary in nature and is in no way intended to limit the disclosure, its application, or uses. For purposes of clarity, the same reference numbers will be used in the drawings to identify similar elements. FIG. 1 illustrates a vehicle 10 having an optical or sensor cleaning system 12. A washing system 14 includes a fluid reservoir 16 and a pump 18. Fluid lines (not shown) connect the pump 18 to window washer nozzles 20 and to at least one sensor or camera assembly 22A-D. A control 32 for the washing system 14 may be mounted in the passenger compartment of the vehicle 10. The vehicle 10 also has a defrost system 15 having defrost controls 33 location within the passenger compartment for the vehicle 10. The defrost system 15 may be connected (not shown) to the HVAC system or various electrical components (not shown), such as wires embedded in the rear window, to provide defrost for the vehicle 10.

With respect to FIGS. 1-7, the sensor/camera assembly 22A-D, 122A-D, 222A-D is described. The sensor/camera assembly 22A-D, 122A-D, 222A-D includes a sensor or camera 24, 124, 224, a nozzle 26, 126, 226 and may also include a defrost element 28, 128, 228. The nozzle 26, 126, 226 and the defrost element 28, 128, 228 are located proximate to the sensor/camera 24, 124, 224. The nozzle 26, 126, 226 and defrost element 28, 128, 228 may or may not be secured to the sensor/camera 24, 124, 224, as is explained in detail below.

The sensor/camera assembly 22A-D, 122A-D, 222A-D is mounted to a vehicle component 30, 130, 230. The vehicle component 30, 130, 230 may be a body panel, a bumper, a grille, etc. for the vehicle 10. The sensor/camera assembly 22A-D, 122A-D, 222A-D is mounted to the vehicle component 30, 130, 230 in a manner that allows the sensor/camera 24, 124, 224 to provide data from the external environment around the vehicle 10.

When the washing system 14 is activated with the control device 32 fluid is sent from the reservoir 16 to the window washer nozzles 20 and the at least one sensor/camera assembly 22A-D, 122A-D, 222A-D. The pump 18 pressurizes the fluid to create a pressure differential between the washer system 14 and atmospheric pressure around the vehicle 10. The pressure differential is sufficient to disperse the fluid through the nozzle 26, 126, 226 and spray or wash over an exterior surface 34, 134, 234 of the sensor/camera 24, 124, 224. The nozzle 26, 126, 226 may be any fluid dispersion device such as a jet nozzle, fan nozzle, other opening or aperture, etc. The angle shape, size and flow rate of the fluid may be determined by the vehicle configuration, the type of sensor/camera assembly 22A-D, 122A-D, 222A-D and the particular location of the sensor/camera assembly 22A-D, 122A-D, 222A-D on the vehicle 10.

A conduit 36, 136, 236 connects the sensor/camera assembly 22A-D, 122A-D, 222A-D to the washer system 14. The sensor/camera assembly 22C-D, 122C-D, 222C-D located at the rear of the vehicle 10 may be fluidly connected (not shown) to the same conduit as a rear window washer nozzle 20. Likewise a sensor/camera assembly 22A-B, 122A-B, 222A-B located at the front of the vehicle 10 may be fluidly connected (not shown) to the same conduit as a front window washer nozzle 20. Therefore, if the forward and rear window washer nozzles 20 operate separately from one another the associated sensor/camera assembly 22A-D, 122A-D, 222A-D will operate at the same time as the respective window washer nozzle 20.

The sensor/camera assembly 22A-D, 122A-D, 222A-D may also include the defrost element 28, 128, 228. The defrost element 28, 128, 228 may be electrically connected to the defrost system 15 and may operate on the same controls 33 as the front and rear defrost for the vehicle 10. Therefore, similar to the washer system 14 the defrost element 28, 128, 228 may be operated at the same time as a respective front or rear window defrost element. Therefore, the washer system 14 and nozzle 26, 126, 226 may be used separately than the defrost element 28, 128, 228 in circumstances when operation of the defrost element 28, 128, 228 is not required, i.e. at warmer temperatures.

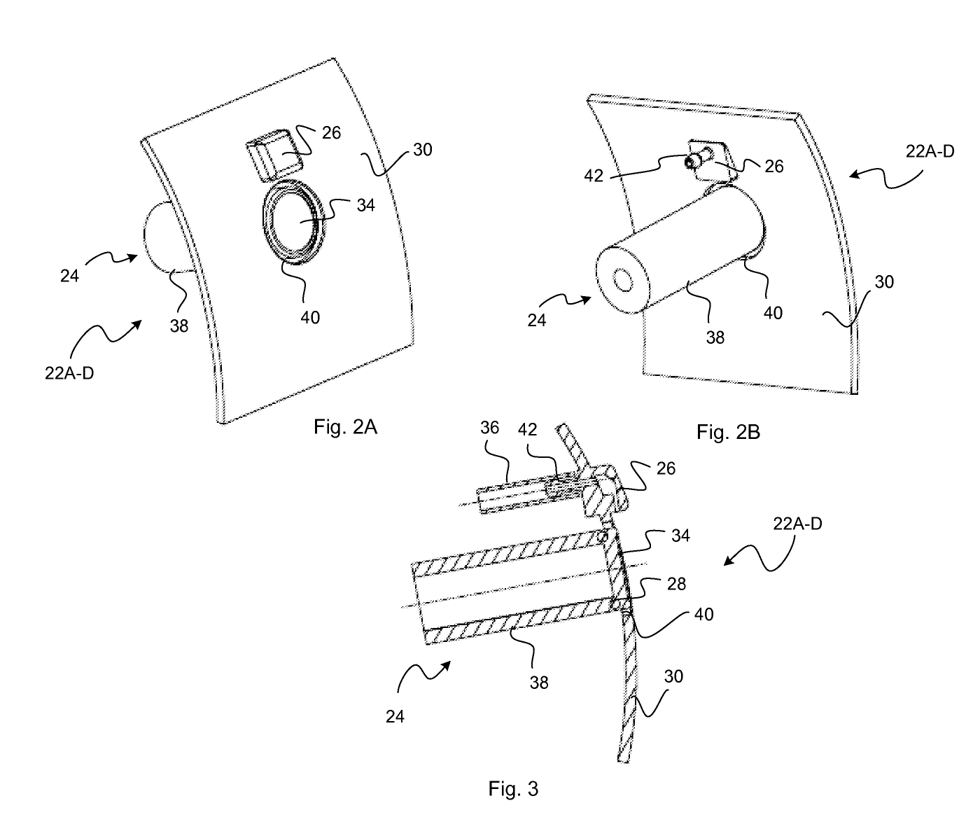

FIGS. 2A-2B and 3 are a schematic illustration of a first embodiment of the sensor/camera assembly 22A-D for the optical and sensor cleaning system 12. The sensor/camera 24 and the defrost element 28 are secured to one another. The defrost element 28 is illustrated as an annular heating element, such as a wire surrounding the sensor/camera 24. However, the defrost element 28 may be any thermoelectric device including a chip style device, such as a PTC (positive thermal coefficient) chip. The defrost element 28 is secured to or incorporated into a housing 38 for the sensor/camera 24.

The vehicle component 30 defines an opening 40 to receive the sensor/camera 24. The housing 38 is secured to the vehicle 10. One skilled in the art would be able to determine the arrangement for securing the housing 38 to the vehicle 10. The vehicle component 30 also defines a channel which is the nozzle 26. The nozzle 26 is proximate to the opening 40 for the sensor/camera 24. Fluid exiting from the nozzle 26 will be directed over the surface 34 of the sensor/camera 24. The fluid may wash dirt and debris away from the surface 34 of the sensor/camera 24. Additionally, the defrost element 28 may be used to defrost the surface 34 of the sensor/camera 24 when required. The defrost element 28 is connected (not shown) to the defrost system 15 and operated with the same controls 33. The vehicle component 30 may also define a boss 42 to receive the conduit 36 to fluidly connect the washer system 14 to the nozzle 26. The conduit 36 is fluidly connected (not shown) to the washer system 14 and control of fluid through the conduit 36 is controlled with the same controls 32.

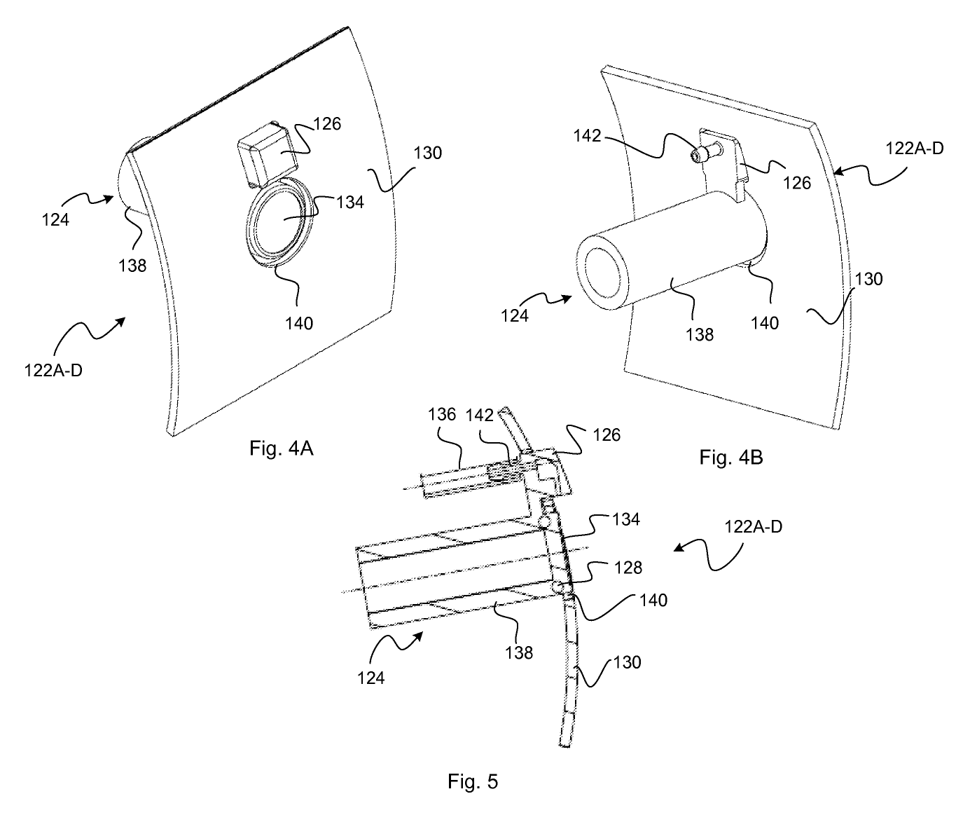

FIGS. 4A-4B and 5 are a schematic illustration of a second embodiment of the sensor/camera assembly 122A-D for the optical and sensor cleaning system 12. The sensor/camera 124 and the defrost element 128 are secured to one another. The defrost element 128 is illustrated as an annular element, such as a wire surrounding the sensor/camera 124. However, the defrost element 128 may also be a chip style device. The defrost element 128 is secured or incorporated into a housing 138 for the sensor/camera 124.

The vehicle component 130 defines an opening 140 to receive the sensor/camera 124. The housing 138 is secured to the vehicle 10. One skilled in the art would be able to determine the arrangement for securing the housing 138 to the vehicle 10. The housing 138 defines a channel which is the nozzle 126. Fluid exiting from the nozzle 126 will be directed over the surface 134 of the sensor/camera 124. The fluid may wash dirt and debris away from the surface 134 of the sensor/camera 124. Additionally, the defrost element 128 may be used to defrost the surface 134 of the sensor/camera 124 when required. The defrost element 128 is connected (not shown) to the defrost system 15 and operated with the same controls 33. The housing 138 may also define a boss 142 to receive the conduit 136 to fluidly connect the washer system 14 to the nozzle 126. The conduit 136 is fluidly connected (not shown) to the washer system 14 and control of fluid through the conduit 136 is controlled with the same controls 32.

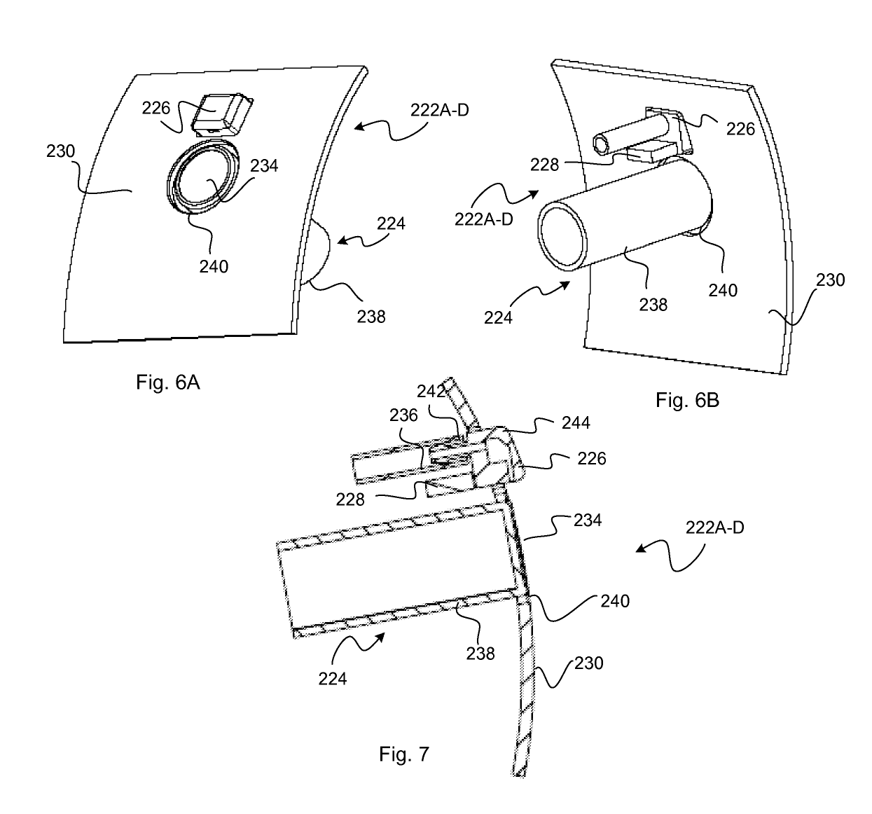

FIGS. 6A-6B and 7 are a schematic illustration of a third embodiment of the electronic device assembly 222A-D for the optical or sensor cleaning system 12. The sensor/camera 224 and the defrost element 228 are located proximate to one another. The defrost element 228 is illustrated as a chip device. However, the defrost element 228 may also be an annular element, such as a wire surrounding the sensor/camera 224. The nozzle 226 is defined by a separate component 244. The defrost element 228 is also a separate component that may secured to the exterior of a housing 238 for the sensor/camera 224, to the vehicle component 230 and/or to the separate component 244 defining the nozzle 226.

The vehicle component 230 defines an opening 240 to receive the sensor/camera 224. The housing 238 is secured to the vehicle 10. One skilled in the art would be able to determine the arrangement for securing the housing 238 to the vehicle 10. The separate component 244 defines a channel which is the nozzle 226. The component 244 is arranged in the opening 240 defined by the vehicle 10 such that the nozzle 226 is proximate to the surface 234 for the sensor/camera 224. Fluid exiting from the nozzle 226 will be directed over the surface 234 of the sensor/camera 224. The fluid may wash dirt and debris away from the surface 234 of the sensor/camera 224. Additionally, the defrost element 228 may be used to defrost the surface 234 of the sensor/camera 224 when required. The defrost element 228 is connected (not shown) to the defrost system 15 and operated with the same controls 33. The separate component 244 may also define a boss 242 to receive the conduit 236 to fluidly connect the washer system 14 to the nozzle 226. The conduit 236 is fluidly connected (not shown) to the washer system 14 and control of fluid through the conduit 236 is controlled with the same controls 232.

Alternatively, the defrost element 28, 128, 228 may be arranged about the nozzle 26, 126, 226 such that the fluid dispersed on the exterior surface 34, 134, 234 of the sensor/camera 24, 124, 224 is sufficiently warmed to defrost any debris that is adhering to the surface 34, 134, 234.

Debris, such as dirt or ice may settle on the vehicle 10 during normal usage. The debris may block or obscure exterior mounted sensors/cameras 24, 124, 224 and may cause signals emitted from externally mounted sensors 24, 124, 224 to dissipate reducing the accuracy and distance over which the sensors 24, 124, 224 operate. Therefore, the camera or sensor cleaning system 12, 112, 212 provides an arrangement and method for cleaning the sensor/camera 24, 124, 224 in various vehicle 10 environments. The sensor/camera assembly 22A-D, 122A-D, 222A-D may therefore be provided as a module for assembly into the vehicle 10 or the sensor/camera 24, 124, 224, defrost element 28, 128, 228 and nozzle 26, 126, 226 may be separated and designed to assemble in the vehicle 10 within proximity to one another. The camera or sensor cleaning system 12, 112, 212 minimizes the reduction in effectiveness and efficiency of the sensor 24, 124, 224 by use of the clean or defrost feature. Maintaining effectiveness and efficiency of the sensor 24, 124, 224 provides a key improvement in safety for the vehicle 10.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A electronic device assembly for a vehicle comprising:
a housing, mountable to a vehicle component;
an electronic device located within the housing and having an exterior facing surface, wherein the electronic device is one of a sensor and camera;
a defrost element located proximate to the electronic device and electrically connectable to a defrost system, wherein the defrost element is arranged to defrost the surface; and
a nozzle located proximate to the electronic device and fluidly connectable to a washer system for the vehicle, wherein the nozzle is arranged to direct a fluid of the washer system over the surface.

2. The electronic device of claim 1, wherein the defrost element is arranged within the housing.

3. The electronic device of claim 2, wherein the defrost element is one of a wire surrounding the electronic device, a thermoelectric device and a PTC chip.

4. The electronic device of claim 1, wherein the housing defines a channel that is the nozzle.

5. The electronic device of claim 1, wherein the vehicle component defines a channel that is the nozzle.

6. The electronic device of claim 1, wherein a separate component defines a channel that is the nozzle, and wherein the separate component is secured to one of the electronic device and the vehicle proximate to the electronic device.

7. The electronic device of claim 1, wherein the vehicle component is one of a body panel, a bumper, and a grille.

8. The electronic device of claim 1, wherein the defrost element is controlled by a defrost control for the defrost system and wherein fluid to the nozzle is separately fluidly controlled by a washer control for the washer system.

10. An electronic device assembly for a vehicle comprising:
a sensor housing, mountable to a vehicle component;
a sensor located within the sensor housing and having an exterior facing surface; and
a nozzle located proximate to the sensor and fluidly connectable to a washer system for the vehicle, wherein the nozzle is arranged to direct a fluid for the washer system over the surface of the sensor.

11. The electronic device assembly of claim 10, further comprising a defrost element located proximate to the sensor.

12. The electronic device assembly of claim 11, wherein the defrost element is located within the sensor housing.

13. The electronic device assembly of claim 11, wherein the defrost element is controlled by a defrost control for the defrost system and wherein fluid to the nozzle is separately fluidly controlled by a washer control from the washer system.

14. The electronic device of claim 11, wherein the defrost element is one of a wire surrounding the sensor, a thermoelectric device and a PTC chip.

15. The electronic device assembly of claim 10, wherein the sensor housing defines a channel that is the nozzle.

16. The electronic device assembly of claim 10, wherein the vehicle component defines a channel that is the nozzle.

17. The electronic device assembly of claim 10, wherein the vehicle component is one of a body panel, a bumper, and a grille.

18. The electronic device assembly of claim 10, wherein the sensor is a camera.

19. A method of cleaning an electronic device for a vehicle comprising:
defrosting a surface of one of a sensor and a camera with a defrost element located proximate to the surface; and
spraying a fluid of a washer system for the vehicle from a nozzle located proximate to the surface over the surface.

20. The method of claim 19, wherein defrosting the surface further comprises controlling the defrost element with a control for the defrost system.

21. The method of claim 19, wherein spraying fluid from the washer system further comprises controlling the fluid flow with a control for the washer system.
